(19) United States
(12) Patent Application Publication
(10) Pub. No.: US 2024/0421444 A1
(43) Pub. Date: Dec. 19, 2024

(54) POWER STORAGE CELL

(71) Applicant: Toyota Jidosha Kabushiki Kaisha, Toyota-shi (JP)

(72) Inventors: Kenichi KAKISHITA, Nagoya-shi (JP); Atsushi Sugihara, Toyota-shi (JP); Jun Izumi, Toyota-shi (JP); Tetsuya Mimura, Chiryu-shi (JP); Kota Ohata, Toyota-shi (JP); Nana Kurashita, Toyota-shi (JP); Yuki Takahashi, Miyoshi-shi (JP)

(73) Assignee: Toyota Jidosha Kabushiki Kaisha, Toyota-shi (JP)

(21) Appl. No.: 18/659,120

(22) Filed: May 9, 2024

(30) Foreign Application Priority Data
Jun. 14, 2023 (JP) 2023-097638

(51) Int. Cl. H01M 50/533; H01M 50/103; H01M 50/15; H01M 50/536; H01M 50/586; H01M 50/59

(52) U.S. Cl. CPC H01M 50/533; H01M 50/103; H01M 50/15; H01M 50/536; H01M 50/586; H01M 50/59

(57) ABSTRACT

A power storage cell includes an electrode assembly, an insulating plate, and a cell case. The electrode assembly includes a plurality of electrodes and a separator. The electrodes include respective current collector foils and active material layers. The electrode assembly includes: an electrode assembly body where respective parts of the current collector foils provided with the active material layers are arranged side by side in one direction with the separator interposed therebetween; and a plurality of current collector tabs formed by respective parts of the current collector foils not provided with the active material layers. The current collector tabs are bent with a part of one current collector tab superposed on an adjacent current collector tab. The insulating plate includes a base portion and a thickness adjusting portion located on an end of the base portion in a second direction. The thickness adjusting portion tapers inward in the second direction.

### CROSS REFERENCE TO RELATED APPLICATIONS

This nonprovisional application is based on Japanese Patent Application No. 2023-097638 filed on Jun. 14, 2023 with the Japan Patent Office, the entire contents of which are hereby incorporated by reference.

### BACKGROUND

### Field

The present disclosure relates to a power storage cell.

### Description of the Background Art

WO2009/031442 discloses a stacked battery including a stack electrode assembly, a current collector lead plate, and a battery can. The stack electrode assembly has a group of current collector tabs formed by bundling a plurality of current collector tabs. The current collector tab group is welded to the lower surface of the current collector lead plate. The current collector lead plate is welded to a lower end of an external terminal provided in the battery can.

### SUMMARY

In the stacked cell described in WO2009/031442, since it is necessary to bundle a plurality of current collector tabs, each current collector tab becomes longer. Therefore, a large space for accommodating a group of current collector tabs formed by bundling a plurality of current collector tabs is required in the battery can.

It is an object of the present disclosure to provide a power storage cell capable of reducing a storage space of a current collector tab.

According to one aspect of the present disclosure, a power storage cell includes: an electrode assembly; an insulating plate disposed in contact with the electrode assembly; and a cell case containing the electrode assembly and the insulating plate, the electrode assembly includes: a plurality of electrodes arranged side by side in one direction; and a separator insulating the plurality of electrodes from each other, the plurality of electrodes include: respective current collector foils; and respective active material layers provided on the current collector foils, the electrode assembly includes: an electrode assembly body in which respective parts of the current collector foils are arranged side by side in the one direction with the separator interposed therebetween, the parts being parts provided with the respective active material layers; and a plurality of current collector tabs formed by respective parts of the current collector foils, the parts being parts that are not provided with the respective active material layers, the plurality of current collector tabs protrude from the electrode assembly body in a first direction orthogonal to the one direction, and the plurality of current collector tabs are arranged side by side in a second direction orthogonal to both the one direction and the first direction, the plurality of current collector tabs are bent in a state where a part of one current collector tab is superposed on another current collector tab adjacent to the one current collector tab, the insulating plate includes: a base portion located between the electrode assembly body and the plurality of current collector tabs, and a thickness adjusting portion located on an end of the base portion in the second direction, and the thickness adjusting portion tapers toward an inside in the second direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage cell according to an embodiment of the present disclosure.

FIG. 2 is a cross-sectional view of the power storage cell shown in FIG. 1.

FIG. 3 is an enlarged cross-sectional view of a part of an electrode assembly.

FIG. 4 is a cross-sectional view showing a modified example of the power storage cell.

### DESCRIPTION OF THE PREFERRED EMBODIMENTS

Embodiments of the present disclosure will be described with reference to the drawings. In the drawings referred to below, the same or corresponding members are denoted by the same reference numerals.

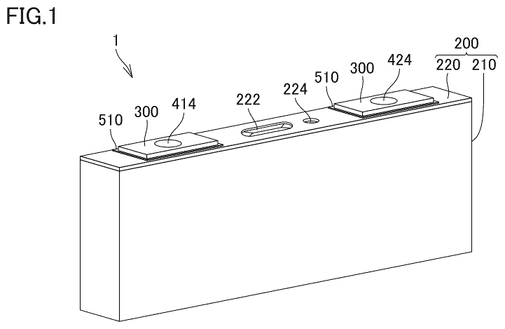

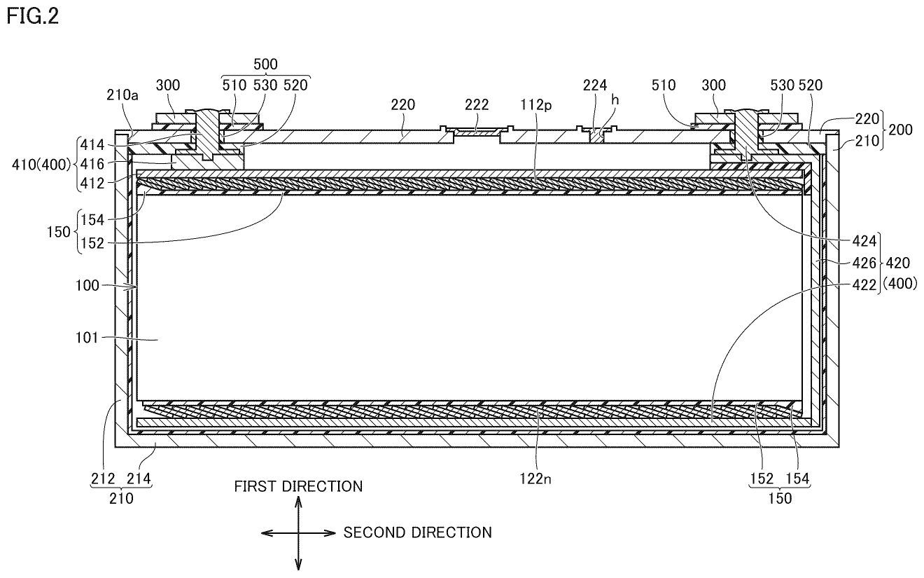

FIG. 1 is a perspective view schematically showing a power storage cell according to an embodiment of the present disclosure. FIG. 2 is a cross-sectional view of the power storage cell shown in FIG. 1.

As shown in FIGS. 1 and 2, the power storage cell 1 includes an electrode assembly 100, a pair of insulating plates 150, a cell case 200, an electrolyte solution (not shown), a pair of external terminals 300, a pair of connecting members 400, and an insulating member 500.

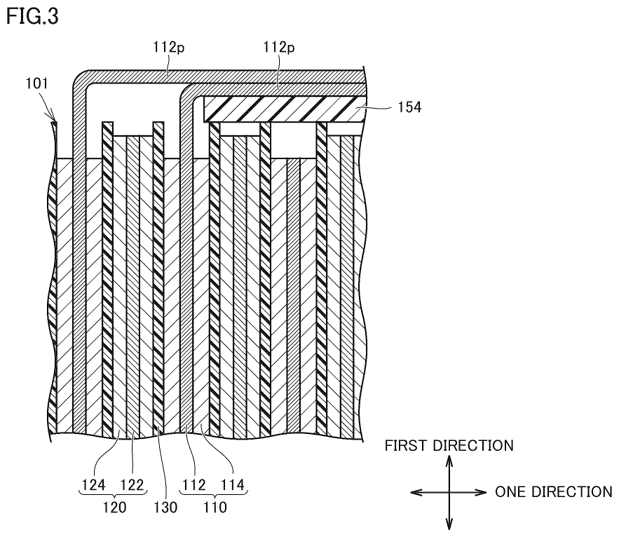

FIG. 3 is an enlarged cross-sectional view of a part of an electrode assembly. As shown in FIG. 3, the electrode assembly 100 includes a plurality of electrodes 110 and 120 and a separator 130.

As shown in FIG. 3, the plurality of electrodes 110 and 120 are arranged side by side in one direction (the left-right direction in FIG. 3). The plurality of electrodes 110 and 120 have a plurality of positive electrodes 110 and a plurality of negative electrodes 120.

Each positive electrode 110 is formed in a rectangular shape elongated in the width direction (direction orthogonal to both one direction and the vertical direction). Each positive electrode 110 includes a positive electrode current collector foil 112 and a positive electrode active material layer 114 provided on both surfaces of the positive electrode current collector foil 112.

Each negative electrode 120 is formed in a rectangular shape elongated in the width direction. Each negative electrode 120 includes a negative electrode current collector foil 122 and a negative electrode active material layer 124 provided on both surfaces of the negative electrode current collector foil 122.

The separator 130 insulates the positive electrode 110 from the negative electrode 120. The separator 130 is made of an insulating material, and has minute voids that allow penetration of ions.

As shown in FIGS. 2 and 3, the electrode assembly 100 includes an electrode assembly body 101 and a plurality of current collector tabs 112p and 122n.

The electrode assembly body 101 is arranged such that portions of the current collector foils 112, 122 on which the active material layers 114, 124 are provided are aligned in one direction with a separator 130 interposed therebetween.

Each of the current collector tabs 112p and 122n is formed by a portion of the current collector foils 112 and 122 where the active material layers 114 and 124 are not provided, and protrudes from the electrode assembly body 101 in the first direction (vertical direction in the present embodiment). Specifically, the plurality of current collector tabs 112p and 122n have a plurality of positive electrode tabs 112p and a plurality of negative electrode tabs 122n. Each positive electrode tab 112p protrudes from the electrode assembly body 101 toward one side in the first direction. Each negative electrode tab 122n protrudes from the electrode assembly body 101 toward the other side in the first direction.

The plurality of current collector tabs 112p and 122n are arranged in a second direction (width direction in the present embodiment) orthogonal to both the one direction and the first direction. The current collector tabs 112p and 122n are bent such that a part of one current collector tab 112p, 122n is superposed on another current collector tab adjacent to the current collector tab 112p, 122n.

Each insulating plate 150 is disposed in contact with the electrode assembly 100. One of the pair of insulating plates 150 is disposed between the electrode assembly body 101 and the plurality of positive electrode tabs 112p, and the other of the pair of insulating plates 150 is disposed between the electrode assembly body 101 and the plurality of negative electrode tabs 122n.

As shown in FIG. 2, each insulating plate 150 includes a base portion 152 and a thickness adjusting portion 154.

The base portion 152 is located between the electrode assembly body 101 and the plurality of current collector tabs 112p, 122n. The base portion 152 is formed in a flat plate shape.

The thickness adjusting portion 154 is provided on an end of the base portion 152 in the second direction. The thickness adjusting portion 154 tapers toward the inside in the second direction.

The cell case 200 houses the electrode assembly 100. The cell case 200 contains an electrolyte solution (not shown). The cell case 200 is sealed. The cell case 200 includes a case body 210 and a lid 220.

The case body 210 has an opening 210a (see FIG. 2) that opens in a direction in which each positive electrode tab 112p protrudes from the electrode assembly body 101. In the present embodiment, the opening 210a is open upward. The case body 210 is made of metal such as aluminum. As shown in FIG. 2, the case body 210 includes a bottom wall 212 and a peripheral wall 214. The bottom wall 212 is formed in a rectangular and flat plate shape. The peripheral wall 214 rises from the bottom wall 212. The peripheral wall 214 is formed in a quadrangular cylindrical shape. The upper end of the peripheral wall 214 forms an opening 210a. The length of the peripheral wall 214 in the width direction is longer than the length of the peripheral wall 214 in the thickness direction. The length of the peripheral wall 214 in the height direction is longer than the length of the peripheral wall 214 in the thickness direction.

The lid 220 closes the opening 210a of the case body 210. The lid 220 is connected to the opening 210a by welding or the like. The lid 220 is formed in a flat plate shape. The lid 220 is made of metal such as aluminum. The lid 220 includes a pressure release valve 222 and a sealing member 224.

The pressure release valve 222 is formed at the center of the lid 220. The pressure release valve 222 is formed so as to break when the internal pressure of the cell case 200 becomes equal to or higher than a predetermined pressure. When the pressure release valve 222 breaks, the gas in the cell case 200 is released to the outside of the cell case 200 through the pressure release valve 222, so that the internal pressure of the cell case 200 decreases.

The sealing member 224 seals the liquid injection port h formed in the lid 220. The liquid injection port h is a through hole for injecting the electrolyte solution into the cell case 200 in the manufacturing process of the power storage cell 1. After the electrolyte solution is injected into the case body 210 through the liquid injection port h, the liquid injection port h is sealed by the sealing member 224.

The pair of external terminals 300 is fixed on the cell case 200. One of the pair of external terminals 300 is a positive electrode external terminal and the other is a negative electrode external terminal. Each external terminal 300 is fixed to the upper surface of the lid 220 via an upper insulating portion 510 described later. Each external terminal 300 is made of a metal such as aluminum. Each external terminal 300 is formed, for example, in a rectangular parallelepiped shape. A bus bar (not shown) is connected to each external terminal 300 by welding or the like.

The pair of connecting members 400 connects the plurality of current collector tabs 112p and 122n to the external terminal 300. The pair of connecting members 400 includes a positive electrode connecting portion 410 that connects the plurality of positive electrode tabs 112p and the positive electrode external terminal 300, and a negative electrode connecting portion 420 that connects the plurality of negative electrode tabs 122n and the negative electrode external terminal 300.

The positive electrode connecting portion 410 includes a positive electrode current collector plate 412, a positive electrode connecting pin 414, and an intermediate member 416.

The positive electrode current collector plate 412 is connected to the plurality of positive electrode tabs 112p by welding or the like. The positive electrode current collector plate 412 is formed in a flat plate shape.

The positive electrode connecting pin 414 is connected to the positive electrode external terminal 300. The positive electrode connecting pin 414 is inserted into a through hole formed in the lid 220 and connected to the positive electrode external terminal 300 by welding, caulking, or the like.

The intermediate member 416 connects the positive electrode current collector plate 412 and the positive electrode connecting pin 414. The lower surface of the intermediate member 416 is connected to the upper surface of the positive electrode current collector plate 412, and the upper surface of the intermediate member 416 is connected to the lower end portion of the positive electrode connecting pin 414.

The negative electrode connecting portion 420 includes a negative electrode current collector plate 422, a negative electrode connecting pin 424 and an intermediate member 426.

The negative electrode current collector plate 422 is connected to a plurality of negative electrode tabs 122n by welding or the like. The negative electrode current collector plate 422 is formed in a flat plate shape.

The negative electrode connecting pin 424 is connected to the negative electrode external terminal 300. The negative electrode connecting pin 424 is inserted into a through hole formed in the lid 220 and connected to the negative electrode external terminal 300 by welding, caulking, or the like.

The intermediate member 426 connects the negative electrode current collector plate 422 and the negative electrode connecting pin 424. A lower end portion of the intermediate member 426 is connected to an end portion of the negative electrode current collector plate 422. The upper surface of the intermediate member 426 is connected to the lower end of the negative electrode connecting pin 424.

The insulating member 500 insulates the cell case 200 from the connecting member 400. The insulating member 500 includes an upper insulating portion 510, a lower insulating portion 520, an insulator 530, and an insulating plate 540.

The upper insulating portion 510 is fixed to the upper surface of the lid 220. The upper insulating portion 510 is disposed between the lid 220 and the external terminal 300. The upper insulating portion 510 is provided with insertion holes through which the connecting pins 414 and 424 are inserted.

The lower insulating portion 520 is fixed to the lower surface of the lid 220. The lower insulating portion 520 is disposed between the lid 220 and the upper surfaces of the intermediate members 416 and 426. The lower insulating portion 520 is provided with insertion holes through which the connecting pins 414 and 424 are inserted.

Insulator 530 is disposed between connecting pins 414 and 424 and lid 220. The insulator 530 is formed in a cylindrical shape and surrounds the connecting pins 414 and 424.

As described above, in the power storage cell 1 according to the present embodiment, the plurality of current collector tabs 112p and 122n are arranged so as to be aligned in the second direction and are bent so as to overlap with the adjacent current collector tabs, so that the space for accommodating the current collector tabs 112p and 122n is reduced. Further, since the thickness adjusting portion 154 of the insulating plate 150 gradually becomes thinner toward the inside in the second direction, a shift between the position of the outer surface of the current collector tabs 112p and 122n arranged at the end portion in the second direction and the position of the outer surface of the other current collector tabs 112p and 122n is reduced.

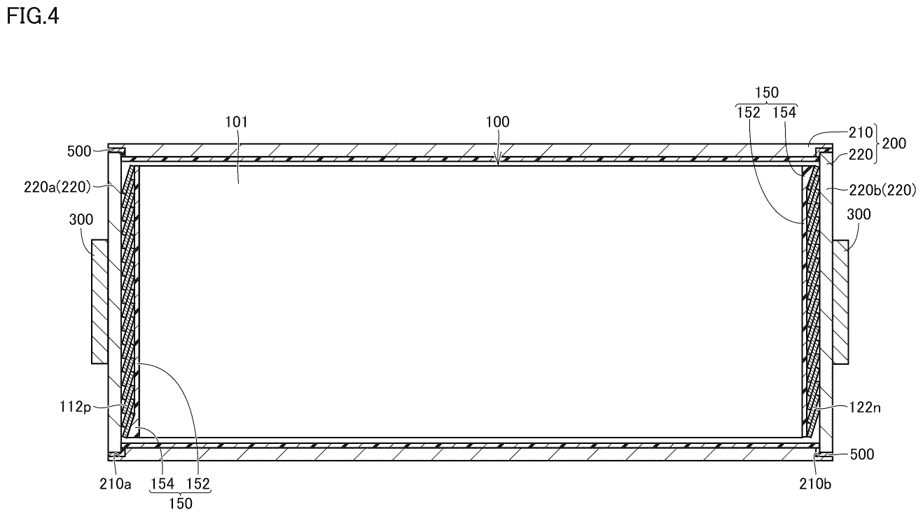

As shown in FIG. 4, the case body 210 may be formed in a cylindrical shape (for example, a quadrangular cylindrical shape), and the lid 220 may have a first lid 220a that closes one opening 210a of the case body 210 and a second lid 220b that closes the other opening 210b of the case body 210. In this case, the connecting member 400 may be omitted. That is, the plurality of positive electrode tabs 112p may be directly connected to the first lid 220a by welding or the like, and the plurality of negative electrode tabs 122n may be directly connected to the second lid 220b by welding or the like. In this case, the insulating member 500 is provided between the case body 210 and each of the lid portions 220a and 220b.

It will be appreciated by those skilled in the art that the exemplary embodiments described above are specific examples of the following aspects.

### Aspect 1

A power storage cell comprising:

an electrode assembly;

an insulating plate disposed in contact with the electrode assembly; and

a cell case containing the electrode assembly and the insulating plate, wherein

the electrode assembly includes:
a plurality of electrodes arranged side by side in one direction; and
a separator insulating the plurality of electrodes from each other,

the plurality of electrodes include:
respective current collector foils; and
respective active material layers provided on the current collector foils,

the electrode assembly includes:
an electrode assembly body in which respective parts of the current collector foils are arranged side by side in the one direction with the separator interposed therebetween, the parts being parts provided with the respective active material layers; and
a plurality of current collector tabs formed by respective parts of the current collector foils, the parts being parts that are not provided with the respective active material layers, the plurality of current collector tabs protrude from the electrode assembly body in a first direction orthogonal to the one direction, and the plurality of current collector tabs are arranged side by side in a second direction orthogonal to both the one direction and the first direction,

the plurality of current collector tabs are bent in a state where a part of one current collector tab is superposed on another current collector tab adjacent to the one current collector tab,

the insulating plate includes:
a base portion located between the electrode assembly body and the plurality of current collector tabs, and
a thickness adjusting portion located on an end of the base portion in the second direction, and

the thickness adjusting portion tapers toward an inside in the second direction.

In this power storage cell, the plurality of current collector tabs are arranged side by side in the second direction and bent in a state where the current collector tab is superposed on an adjacent current collector tab, and therefore, the space for accommodating the current collector tabs is reduced. Further, the thickness adjusting portion of the insulating plate tapers toward the inside in the second direction, which reduces the deviation between the position of the outer surface of the current collector tab arranged at the end in the second direction and the position of the outer surface of other current collector tabs.

### Aspect 2

The power storage cell according to Aspect 1, wherein

the cell case includes:
a case body having an opening that opens in a direction in which the plurality of current collector tabs protrude from the electrode assembly body; and
a lid closing the opening of the case body, and

the plurality of current collector tabs are welded to the lid.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell comprising:
an electrode assembly;
an insulating plate disposed in contact with the electrode assembly; and
a cell case containing the electrode assembly and the insulating plate, wherein
the electrode assembly includes:
a plurality of electrodes arranged side by side in one direction; and
a separator insulating the plurality of electrodes from each other, the plurality of electrodes include:
respective current collector foils; and
respective active material layers provided on the current collector foils,
the electrode assembly includes:
an electrode assembly body in which respective parts of the current collector foils are arranged side by side in the one direction with the separator interposed therebetween, the parts being parts provided with the respective active material layers; and
a plurality of current collector tabs formed by respective parts of the current collector foils, the parts being parts that are not provided with the respective active material layers, the plurality of current collector tabs protrude from the electrode assembly body in a first direction orthogonal to the one direction, and the plurality of current collector tabs are arranged side by side in a second direction orthogonal to both the one direction and the first direction,
the plurality of current collector tabs are bent in a state where a part of one current collector tab is superposed on another current collector tab adjacent to the one current collector tab,
the insulating plate includes:
a base portion located between the electrode assembly body and the plurality of current collector tabs, and
a thickness adjusting portion located on an end of the base portion in the second direction, and
the thickness adjusting portion tapers toward an inside in the second direction.

2. The power storage cell according to claim 1, wherein
the cell case includes:
a case body having an opening that opens in a direction in which the plurality of current collector tabs protrude from the electrode assembly body; and
a lid closing the opening of the case body, and
the plurality of current collector tabs are welded to the lid.
